(19) United States
(12) Patent Application Publication
(10) Pub. No.: US 2025/0246845 A1
(43) Pub. Date: Jul. 31, 2025

(54) SNAP-IN BEZEL FOR RECEPTACLE AND AN ASSEMBLY THEREOF

(71) Applicant: Kewaunee Scientific Corporation, Statesville, NC (US)

(72) Inventors: Karole Denise CLANTON, Stony Point, NC (US); Jeremy Shaun MILLER, Conover, NC (US)

(21) Appl. No.: 19/040,313

(22) Filed: Jan. 29, 2025

Related U.S. Application Data
(60) Provisional application No. 63/627,332, filed on Jan. 31, 2024.

(51) Int. Cl. H01R 13/506; H01R 13/10; H01R 13/518; H01R 25/00; H01R 103/00

(52) U.S. Cl. CPC H01R 13/506; H01R 13/10; H01R 13/518; H01R 25/006; H01R 2103/00

(57) ABSTRACT

A bezel with a body having a front face, a back, and at least one edge having at least one bezel body snap tab; at least one hole in the bezel face for engagement with a receptacle face of a receptacle, and at least one outlet snap tab on the back of the body of the bezel for locking engagement with the receptacle. An assembly of a receptacle lockingly engaged with a bezel, the bezel with a body having a front face, a back, and at least one edge having at least one bezel body snap tab; at least one hole in the bezel face for engagement with a receptacle face of a receptacle; and at least one outlet snap tab on the back of the body of the bezel for locking engagement with the receptacle.

### CROSS-REFERENCE TO RELATED APPLICATIONS

This application claims priority from U.S. Provisional Patent Application No. 63/627,332 filed on Jan. 31, 2024, in the United States Patent and Trademark Office. The disclosure of which is incorporated herein by reference in its entirety.

### FIELD OF THE INVENTION

The present invention relates to a bezel for a receptacle, more particularly a snap-in bezel for a receptacle and an assembly therefor.

### BACKGROUND OF THE INVENTION

A conventional receptacle installation utilizes screws or threaded studs and nuts to attach a bezel assembly to a box or structure and may also require the addition of a separate aesthetical face plate with screws.

The bezel and bezel-receptacle assembly of the present invention overcomes the disadvantages associated with conventional receptacle assemblies.

### SUMMARY OF THE INVENTION

The present invention relates to a bezel for a receptacle and a bezel-receptacle assembly.

In an aspect of the invention, a bezel comprises: a body having a front face, a back, and at least one edge having at least one bezel body snap tab; at least one hole in the bezel face for engagement with a receptacle face of a receptacle; and at least one outlet snap tab on the back of the body of the bezel for locking engagement with the receptacle.

In an aspect of the invention, an assembly comprises a receptacle lockingly engaged with a bezel, the bezel comprising: a body having a front face, a back, and at least one edge having at least one bezel body snap tab; at least one hole in the bezel face for engagement with a receptacle face of a receptacle; and at least one outlet snap tab on the back of the body of the bezel for locking engagement with the receptacle.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a front view of a bezel having a snap-in feature for use with a dual receptacle in accordance with an aspect of the present invention.

FIG. 2 is a back view of the bezel of FIG. 1.

FIG. 3 is a top view of the bezel of FIG. 1.

FIG. 4 is a side view of the bezel of FIG. 1.

FIG. 5 is a front view of a bezel having a snap-in feature for use with a Ground Fault Circuit Interrupter (GFCI) receptacle in accordance with an aspect of the present invention.

FIG. 6 is a back view of the bezel of FIG. 5.

FIG. 7 is a top view of the bezel of FIG. 5.

FIG. 8 is a side view of the bezel of FIG. 5.

FIG. 9A is a side view of a front of a bezel having a snap-in feature for locking engagement with a dual receptacle in accordance with an aspect of the present invention.

FIG. 9B is a side view of a back of a bezel having a snap-in feature for locking engagement with a dual receptacle in accordance with an aspect of the present invention.

FIG. 9C is a side view of a bezel having a snap-in feature shown in locking engagement with a dual receptacle in accordance with an aspect of the present invention.

FIG. 10A is a side view of a front of a bezel having a snap-in feature for locking engagement with a GFCI receptacle in accordance with an aspect of the present invention.

FIG. 10B is a side view of a back of a bezel having a snap-in feature for locking engagement with a GFCI receptacle in accordance with an aspect of the present invention.

FIG. 10C is a side view of a bezel having a snap-in feature in locking engagement with a GFCI receptacle in accordance with an aspect of the present invention.

FIG. 11A is an illustration of a bezel and receptacle assembly having a dual receptacle prior to insertion in an opening of a surface structure.

FIG. 11B is an illustration of the bezel and receptacle assembly having a dual receptacle of FIG. 11A inserted in an opening of a surface structure.

FIG. 12A is an illustration of the bezel and receptacle assembly having a GFCI receptacle prior to insertion in an opening of a surface structure.

FIG. 12B is an illustration of the bezel and receptacle assembly having a GFCI receptacle of FIG. 12A inserted in an opening of a surface structure.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

Further, the term “or” as used in this disclosure and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in,” “at,” and/or “on,” unless the context clearly indicates otherwise. The phrase “in one embodiment,” as used herein does not necessarily refer to the same embodiment, although it may.

The present invention relates to a bezel having a snap-in feature for locking engagement with a receptacle and to a combined bezel and receptacle assembly. The receptacle is a socket that connects an electrical device to an electricity supply. A receptacle is often commonly referred to as an electrical outlet.

In an aspect of the invention, the bezel comprises a body having a front face, a back, and at least one edge having at least one bezel body snap tab; at least one hole in the bezel face for engagement with a receptacle face of a receptacle, and at least one outlet snap tab on the back of the body of the bezel for locking engagement with the receptacle.

There are many types of receptacles that are suitable for use with the bezel of the present invention and in the combined bezel and receptacle assembly of the present invention. Examples of receptacles include, but are not limited to, a two-pronged receptacle, grounded receptacle, tamper-resistant receptacle (TRR), arc fault circuit (AFC) receptacle, ground fault circuit interrupter (GFCI), surge suppression receptacle, USB receptacle, among others. Some receptacles may combine more than one such technology.

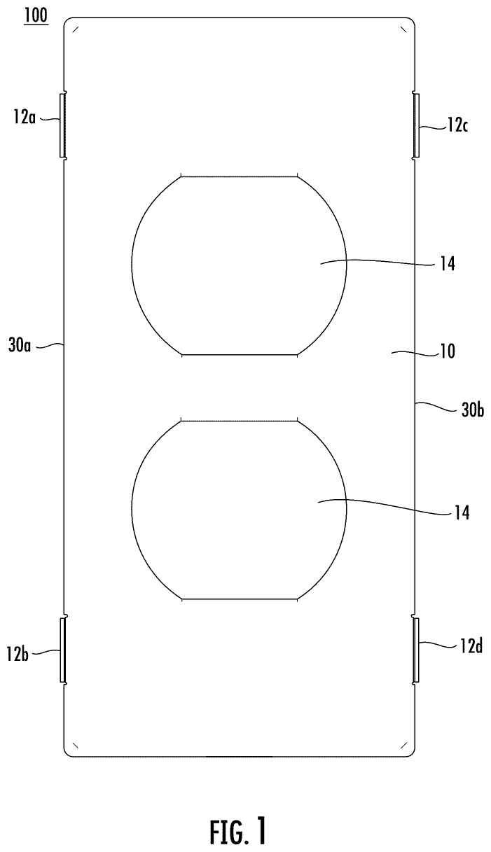

Referring to the figures, FIG. 1 is a front view of a bezel 100 having a snap-in feature for use with a dual receptacle in accordance with an aspect of the present invention. The bezel 100 of FIG. 1 has a front face 10 with two holes 14 shown for engagement with two receptacle faces (not shown). As shown, front face 10 is rectangular in shape and has a bezel body 30. Bezel body 30 has two bezel body snap tabs (12a, 12b) that are separated by a distance from one another on an edge 30a of bezel body 30 and two bezel body snap tabs (12c, 12d) that are separated by a distance from one another on an opposing edge 30b of bezel body 30.

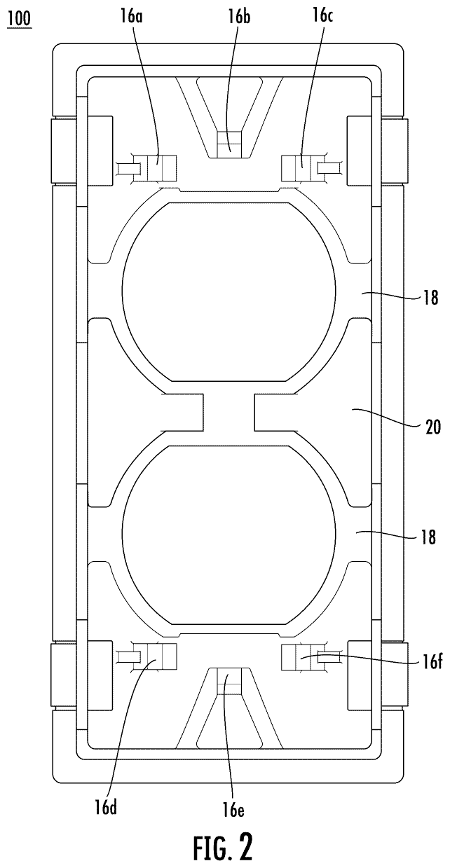

FIG. 2 is a back view of the bezel 100 of FIG. 1. As shown in FIG. 2, there are multiple outlet snap tabs on bezel back 20. As shown, there are three outlet snap tabs (16a, 16b, 16c) above the top hole and three outlet snap tabs (16d, 16e, 16f) below the bottom hole. The number and location of the outlet snap tab(s) may vary. The back may further comprise a reinforcement rib(s) 18. Reinforcement rib(s) 18 may be placed in various locations on the back of the bezel such as, for example, around the holes.

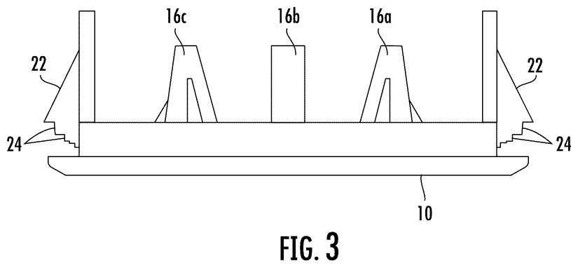

FIG. 3 is a top view of bezel 100 of FIG. 1. As shown in FIG. 3, there are one or more bezel body snap tabs 22. Bezel body snap tab 22 has one or more steps 24 for various metal thicknesses. The bezel body snap tabs are used to install a combined bezel and receptacle assembly in a surface structure. The entire assembly is capable of being snapped directly into a rectangular opening or cutout, for example.

Bezel body snap tabs 22 which are semi-concealed also serve as unlocking tabs capable of being depressed and disengaged allowing the entire assembly to be removed from an opening or cutout within a structure, if necessary.

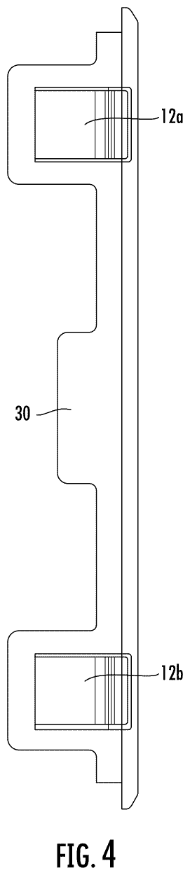

FIG. 4 is a side view of the bezel of FIG. 1 illustrating bezel body snap tabs 12a, 12b on bezel body 30.

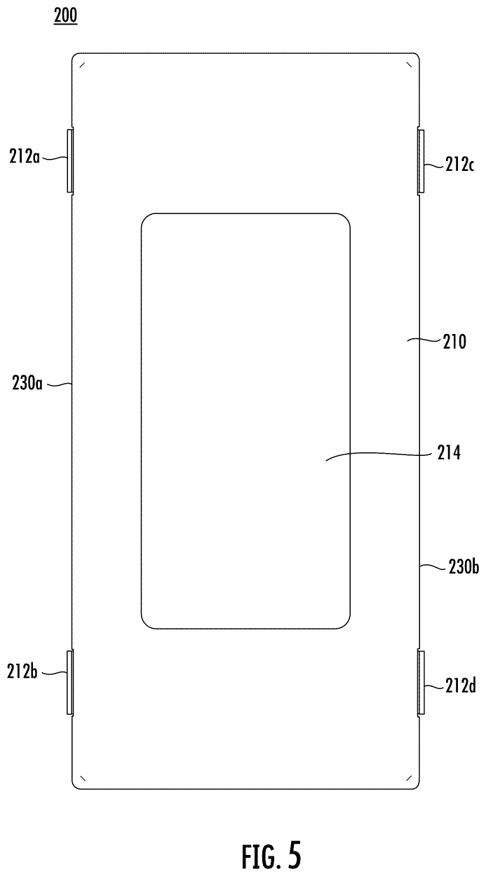

FIG. 5 is a front view of a bezel 200 having a snap-in feature for use with a Ground Fault Circuit Interrupter (GFCI) receptacle in accordance with an aspect of the present invention. Bezel 200 of FIG. 5 has a front face 210 with a single hole 214 for engagement with the GFCI receptacle face (not shown). As shown, the bezel and the hole are generally rectangular in shape.

A bezel body 230 has two bezel body snap tabs (212a, 212b) that are separated by a distance from one another on an edge 230a of bezel body 230 and two bezel body snap tabs (212c, 212d) that are separated by a distance from one another on an opposing edge 230b of bezel body 230.

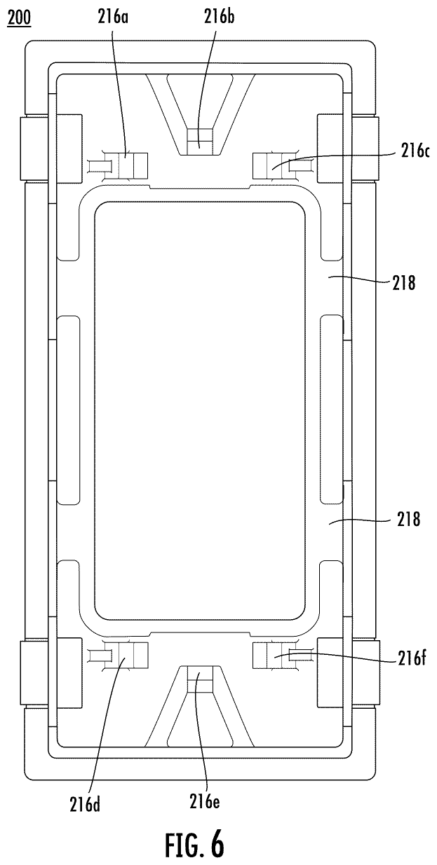

FIG. 6 is a back view of bezel 200 of FIG. 5. As shown in FIG. 6, there are outlet snap tabs on the bezel back. As shown, there are three outlet snap tabs (216a, 216b, 216c) above the hole and three outlet snap tabs (216d, 216e, 216f) below the hole. The number and location of the outlet snap tab(s) may vary. The back may further comprise reinforcement ribs 218. Reinforcement ribs may be placed in various locations on the back of the bezel such as, for example, around the hole.

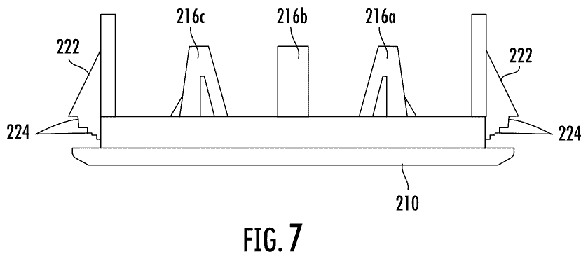

FIG. 7 is a top view of bezel 200 of FIG. 5. As shown in FIG. 7, there are one or more bezel body snap tabs 222. Bezel body snap tab 222 has one or more steps 224 for various metal thicknesses. Bezel body snap tab(s) 222 are used to install the combined bezel and receptacle assembly in a surface structure. The entire assembly is capable of being snapped directly into a rectangular opening or cutout, for example.

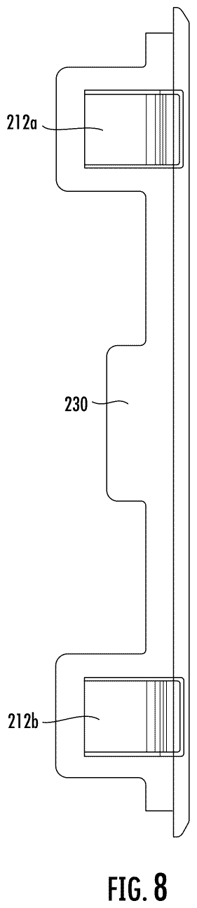

FIG. 8 is a side view of the bezel of FIG. 5 illustrating bezel body snap tab(s) 212a, 212b on bezel body 230.

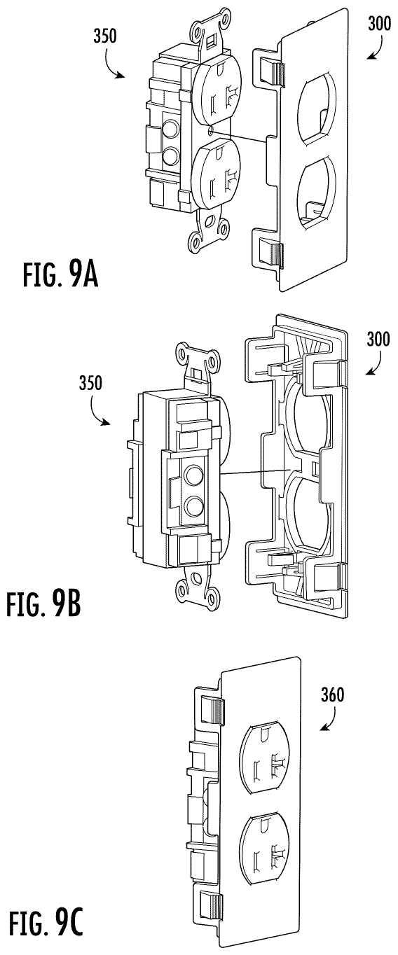

FIG. 9A is a side view of a front of a bezel 300 having a snap-in feature for locking engagement with a dual receptacle 350 in accordance with an aspect of the present invention.

FIG. 9B is a side view of a back of a bezel 300 having a snap-in feature for locking engagement with a dual receptacle 350 in accordance with an aspect of the present invention.

FIG. 90 is a side view of a bezel 300 having a snap-in feature shown in locking engagement with a dual receptacle 350 to form an assembly 360 in accordance with an aspect of the present invention.

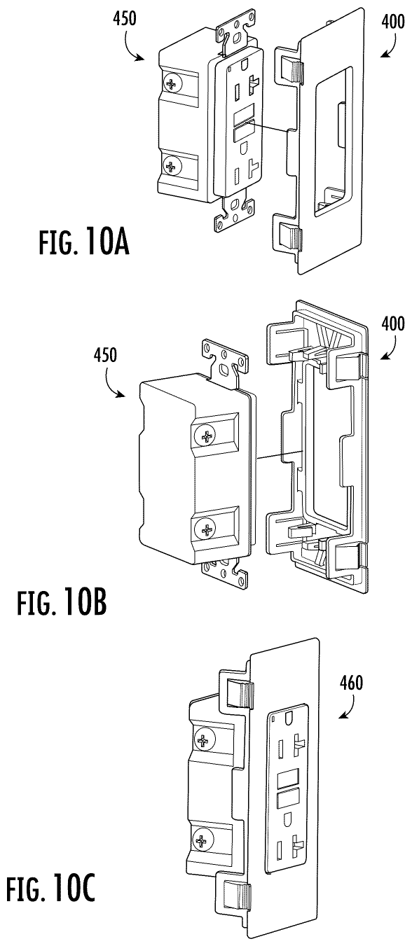

FIG. 10A is a side view of a front of a bezel 400 having a snap-in feature for locking engagement with a GFCI receptacle 450 in accordance with an aspect of the present invention.

FIG. 10B is a side view of a back of a bezel 400 having a snap-in feature for locking engagement with a GFCI receptacle 450 in accordance with an aspect of the present invention.

FIG. 10C is a side view of a bezel 400 having a snap-in feature in locking engagement with a GFCI receptacle 450 to form an assembly 460 in accordance with an aspect of the present invention.

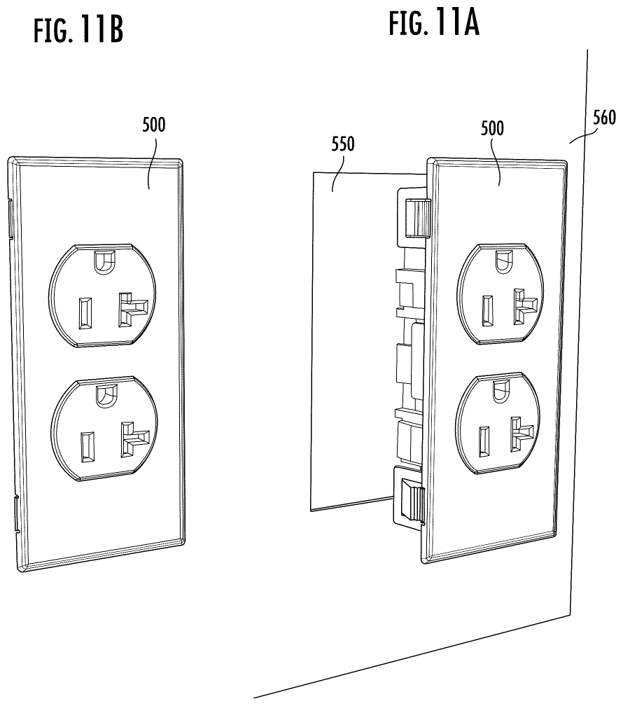

FIG. 11A is an illustration of a bezel and receptacle assembly 500 having a dual receptacle prior to insertion in an opening 550 of a surface structure 560.

FIG. 11B is an illustration of the bezel and receptacle assembly 500 having a dual receptacle of FIG. 11A inserted in the opening of the surface structure.

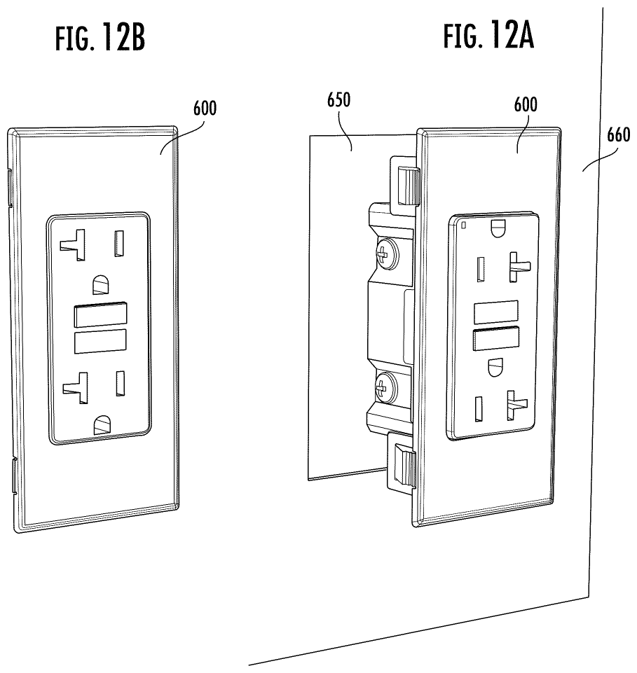

FIG. 12A is an illustration of a bezel and receptacle assembly 600 having a GFCI receptacle prior to insertion in an opening 650 of a surface structure 660.

FIG. 12B is an illustration of the bezel and receptacle assembly 600 having a GFCI receptacle of FIG. 12A inserted in the opening of the surface structure.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A bezel comprising:
a body having a front face, a back, and at least one edge having at least one bezel body snap tab,
at least one hole in the bezel face for engagement with a receptacle face of a receptacle, and
at least one outlet snap tab on the back of the body of the bezel for locking engagement with the receptacle.

2. The bezel according to claim 1, wherein the back further comprises a reinforcement rib.

3. The bezel according to claim 1, wherein the bezel body snap tab has one or more steps.

4. The bezel according to claim 1, having multiple outlet snap tabs on the bezel body.

5. The bezel according to claim 1, wherein the receptacle is selected from the group consisting of a two-pronged receptacle, grounded receptacle, tamper-resistant receptacle (TRR), arc fault circuit (AFC) receptacle, ground fault circuit interrupter (GFCI), surge suppression receptacle, USB receptacle, and a combination thereof.

6. An assembly comprising:
a receptacle lockingly engaged with a bezel, the
a bezel comprising:
a body having a front face, a back, and at least one edge having at least one bezel body snap tab,
at least one hole in the bezel face for engagement with a receptacle face of a receptacle, and
at least one outlet snap tab on the back of the body of the bezel for locking engagement with the receptacle.

7. The assembly according to claim 6, wherein the back of the bezel body further comprises a reinforcement rib.

8. The bezel according to claim 6, wherein the bezel body snap tab has one or more steps.

9. The bezel according to claim 6, having multiple outlet snap tabs on the bezel body.

10. The bezel according to claim 6, wherein the receptacle is selected from the group consisting of a two-pronged receptacle, grounded receptacle, tamper-resistant receptacle (TRR), arc fault circuit (AFC) receptacle, ground fault circuit interrupter (GFCI), surge suppression receptacle, USB receptacle, and a combination thereof.
